(19) United States
(12) Patent Application Publication
(10) Pub. No.: US 2010/0279608 A1
(43) Pub. Date: Nov. 4, 2010

(54) Bluetooth device

(76) Inventor: Wang Shi-En, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,699

(22) Filed: Aug. 21, 2009

(30) Foreign Application Priority Data
Apr. 30, 2009 (CN) 200910039187.5

(51) Int. Cl. H04B 7/00

(52) U.S. Cl. 455/41.2

(57) ABSTRACT

A Bluetooth device is adapted to be carried on a human body, and includes: a Bluetooth module wirelessly receiving an external audio signal; a loudspeaker module for reproducing the audio signal received by the Bluetooth module; a sensing unit including a sensing circuit for sensing a conductive unit so as to generate a physical characteristic value associated with the conductive unit; and a processing unit receiving the physical characteristic value from the sensing circuit, and outputting a control signal to the Bluetooth module based on the physical characteristic value received thereby. The Bluetooth module is operable, based on the control signal from the processing unit, between one of a power-saving state, where the Bluetooth device is distal from the human body, and a working state, where the Bluetooth device is close to the human. body.

### CROSS-REFERENCE TO RELATED APPLICATION

This application claims priority of Chinese Application No. 200910039187.5, filed on Apr. 30, 2009.

### BACKGROUND OF THE INVENTION

1. Field of the Invention

The invention relates to a Bluetooth device, more particularly to a Bluetooth device capable of power saving.

2. Description of the Related Art

A conventional Bluetooth earphone is adapted for use with an electronic device, such as a mobile phone or a music player. In use, after a predetermined time period during which the conventional Bluetooth earphone has not received any audio signal from a mobile phone, e.g., the mobile phone is hung up, the conventional Bluetooth earphone is operated in a standby mode, where a relatively small amount of battery power is exhausted, thereby prolonging a power-supplying period of a battery unit of the conventional Bluetooth earphone.

When the conventional Bluetooth earphone is used with an MP3 player, the MP3 player transmits an audio signal to the conventional Bluetooth earphone during playing. However, the conventional Bluetooth earphone is maintained in a working mode, where a relatively large amount of battery power is exhausted, during playing of the MP3 player even though the conventional Bluetooth earphone is departed from an ear portion of a user. this case, only when the MP3 player is turned off, the conventional Bluetooth earphone is switched from the working mode to the standby mode. As a result, after the conventional Bluetooth earphone is removed from the ear portion of the user, unnecessary waste of battery power occurs prior to turning off of the MP3 player, thereby shortening the power-supplying period of the battery unit of the conventional Bluetooth earphone.

Therefore, it is desired to design a Bluetooth device that can be properly switched between a working state and a power-saving state.

### SUMMARY OF THE INVENTION

Therefore, an object of the present invention is to provide a Bluetooth device that can be properly switched to a power-saving state when the Bluetooth device is removed from a human body.

According to the present invention, there is provided a Bluetooth device adapted to be carried on a human body. The Bluetooth device comprises:
a Bluetooth module adapted to wirelessly receive an external audio signal;
a loudspeaker module coupled to the Bluetooth module for reproducing the audio signal received by the Bluetooth module;
a sensing unit including
   a conductive unit, and
   a sensing circuit coupled to the conductive unit for sensing the conductive unit so as to generate a physical characteristic value associated with the conductive unit; and
a processing unit coupled to the sensing circuit of the sensing unit and the Bluetooth module, receiving the physical characteristic value from the sensing circuit of the sensing unit, and outputting a control signal to the Bluetooth module based on the physical characteristic value received thereby.

The Bluetooth module is operable, based on the control signal from the processing unit, between one of a power-saving state, where the Bluetooth device is distal from the human body, and a working state, where the Bluetooth device is close to the human body.

Preferably, the Bluetooth device of the present invention further comprises a casing for housing the Bluetooth module, the loudspeaker module, the sensing unit and the processing unit therein. The casing is adapted to be worn on one of a head portion and an ear portion of the human body.

Preferably, when the casing is worn on said one of the head portion and the ear portion of the human body, the Bluetooth module is operated in the working state based on the control signal from the processing unit. When the casing is departed from said one of the head portion and the ear portion of the human body, the Bluetooth module is operated in the power-saving state based on the control signal from the processing unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing the preferred embodiment of a Bluetooth device according to the present invention;

FIG. 2 is a schematic circuit block diagram illustrating the preferred embodiment; and

FIG. 3 is a schematic view illustrating a sensing unit of the preferred embodiment in a state of use.

### DETAILED DESCRIPTION OF THE PREFERRED EMBODIMENT

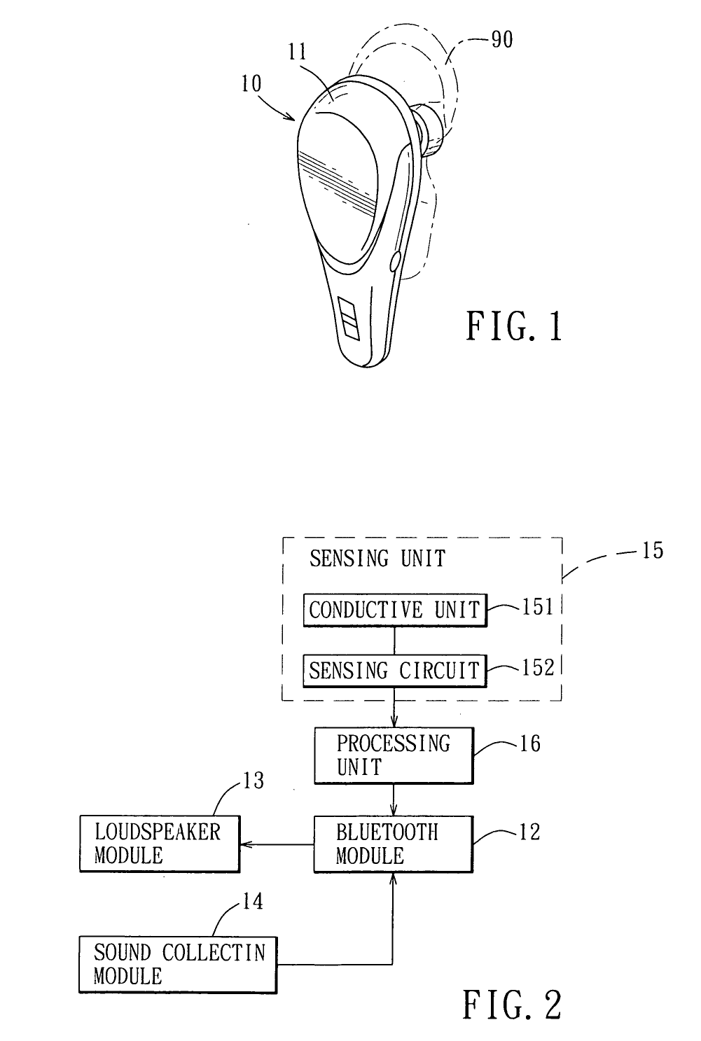

Referring to FIGS. 1 and 2, the preferred embodiment of a Bluetooth device 10 according to the present invention is shown to include a casing 11, a Bluetooth module 12, a loudspeaker module 13, a sensing unit 15, a processing unit 16, and a sound collecting module 14. In this embodiment, the Bluetooth device 10 is a Bluetooth earphone that is adapted for use with a mobile phone (not shown) capable of Bluetooth transmission. In other embodiments, the Bluetooth device 10 can be used with a portable electronic device, such as a music player, capable of Bluetooth transmission.

In this embodiment, the casing 11 is adapted to be worn on an ear portion 90 of a human body, and houses the Bluetooth module 12, the loudspeaker module 13, the sensing unit 15, the processing unit 16 and the sound collecting module 14 therein. In other embodiments, the casing 11 is adapted to be worn on a head portion of a human body.

The Bluetooth module 12 is adapted to wirelessly receive an external audio signal from the portable electronic device.

The loudspeaker module 13 is coupled to the Bluetooth module 12 for reproducing the audio signal received by the Bluetooth module 12.

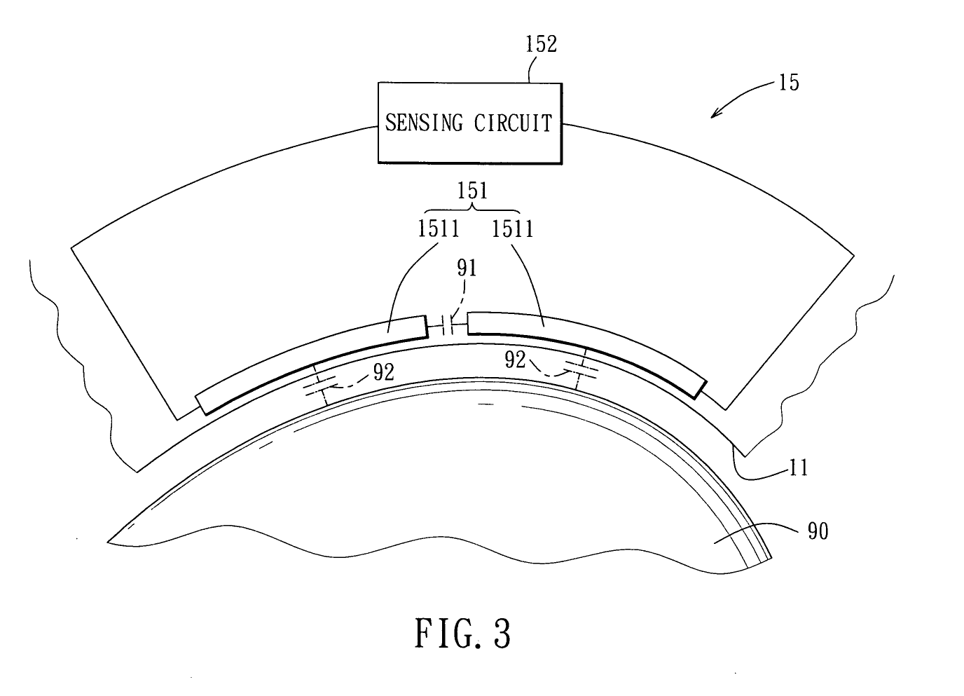

The sensing unit 15 includes a conductive unit 151, and a sensing circuit 152 coupled to the conductive unit 151 for sensing the conductive unit 151 so as to generate a physical characteristic value associated with the conductive unit 151. In this embodiment, the sensing unit 15 is a capacitive sensing unit. Referring further to FIG. 3, the conductive unit 151 includes two conductors 1511 spaced apart from each other such that an intrinsic capacitance 91 is formed between the conductors 1511. The sensing circuit 152 senses a capacitance across the conductive unit 151 so as to generate a capacitance value serving as the physical characteristic value. In such a configuration, when the casing 11 is worn on the ear portion 90 of the human body, i.e., the Bluetooth device 10 is close to the human body such that a coupling capacitance 92 is formed between each conductor 1511 and the ear portion 90 serving as a conductor. Thus, the capacitance value generated by the sensing circuit 152 is equal to a capacitance value of a parallel connection of the intrinsic capacitance 91 and two series coupling capacitances 92. In this case, the capacitance value generated by the sensing circuit 152 is larger than that of the intrinsic capacitance 91 formed between the conductors 1511. On the other hand, when the casing 11 is departed from the ear portion 90 of the human body, i.e. the Bluetooth device 10 is distal from the human body, the capacitance value generated by the sensing circuit 152 is equal to the capacitance value of the intrinsic capacitance 91. It is noted that, in other embodiments, the sensing unit 15 can include a signal radiating element for radiating an optical signal, such as a laser signal or an infrared signal, and a receiving element for receiving the optical signal radiating from the signal radiating element so as to generate an output signal indicating whether the casing 11 is worn on the ear portion 90 of the human body.

The processing unit 16 is coupled to the sensing circuit 152 of the sensing unit 15 and the Bluetooth module 12. The processing unit 16 receives the physical characteristic value from the sensing circuit 152 of the sensing unit 15, and outputs a control signal to the Bluetooth module 12 based on the physical characteristic value received thereby.

The Bluetooth module 12 is operable, based on the control signal from the processing unit 16, between one of a power-saving state, where the Bluetooth device 10 is distal from the human body, and a working state, where the Bluetooth device 10 is close to the human body. In this embodiment, when the processing unit 16 detects that the capacitance value generated by the sensing circuit 152 is equal to the capacitance value of the intrinsic capacitance 91 that serves as a predetermined value in this embodiment, that is, the casing 11 is departed from the ear portion 90, the processing unit 16 outputs the control signal to the Bluetooth module 12 such that the Bluetooth module 12 is operated in the power-saving state. When the processing unit 16 detects the capacitance value generated by the sensing circuit 152 is larger than the predetermined value, that is, the casing is worn on the ear portion 90, the processing unit 16 outputs the control signal to the Bluetooth module 12 such that the Bluetooth module 12 is operated in the working state.

The sound collecting module 14 is coupled to the Bluetooth module 12, collects sound from a user to generate an audio signal, and outputs the audio signal to the Bluetooth module 12. The Bluetooth module 12 receives the audio signal from the sound collecting module 14, and is adapted to transmit the audio signal to the mobile phone.

In sum, due to the presence of the sensing unit 15 the Bluetooth module 12 can be properly switched to the power-saving state through control of the processing unit 16 when the casing 11 is departed from the ear portion 90. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A Bluetooth device adapted to be carried on a human body, comprising:
a Bluetooth module adapted to wirelessly receive an external audio signal;
a loudspeaker module coupled to said Bluetooth module for reproducing the audio signal received by said Bluetooth module;
a sensing unit including
a conductive unit, and
a sensing circuit coupled to said conductive unit for sensing said conductive unit so as to generate a physical characteristic value associated with said conductive unit; and
a processing unit coupled to said sensing circuit of said sensing unit and said Bluetooth module, receiving the physical characteristic value from said sensing circuit of said sensing unit, and outputting a control signal to said Bluetooth module based on the physical characteristic value received thereby;
wherein said Bluetooth module is operable, based on the control signal from said processing unit, between one of a power-saving state, where said Bluetooth device is distal from the human body, and a working state, where said Bluetooth device is close to the human body.

2. The Bluetooth device as claimed in claim 1, further comprising a casing for housing said Bluetooth module, said loudspeaker module, said sensing unit and said processing unit therein, said casing being adapted to be worn on one of a head portion and an ear portion of the human body.

3. The Bluetooth device as claimed in claim 2, wherein:
when said casing is worn on said one of the head portion and the ear portion of the human body, said Bluetooth module is operated in the working state based on the control signal from said processing unit; and
when said casing is departed from said one of the head portion and the ear portion of the human body, said Bluetooth module is operated in the power-saving state based on the control signal from said processing unit.

4. The Bluetooth device as claimed in claim 1, wherein:
said conductive unit of said sensing unit includes a plurality of conductors spaced apart from each other;
said sensing circuit of said sensing unit senses a capacitance across said conductive unit so as to generate a capacitance value serving as the physical characteristic value;
said processing unit outputs the control signal to said Bluetooth module upon detecting that the capacitance value is equal to a predetermined value such that said Bluetooth module is operated in the power-saving state; and
said processing unit outputs the control signal to said Bluetooth module upon detecting that the capacitance value is larger than the predetermined value such that said Bluetooth module is operated in the working state.
